(19) United States
(12) Patent Application Publication
(10) Pub. No.: US 2015/0300958 A1
(43) Pub. Date: Oct. 22, 2015

(54) ADJUSTABLE COLORIMETRIC MOISTURE INDICATORS

(71) Applicant: 3M INNOVATIVE PROPERTIES COMPANY, Saint Paul,, MN (US)

(72) Inventors: EVAN KOON LUN YUUJI HAJIME, WOODBURY, MN (US); MYUNGCHAN KANG, WOODBURY, MN (US)

(73) Assignee: 3M INNOVATIVE PROPERTIES COMPANY, Saint Paul, MN (US)

(21) Appl. No.: 14/441,472

(22) PCT Filed: Nov. 14, 2013
(86) PCT No.: PCT/US13/70163

§ 371 Date: May 7, 2015

Related U.S. Application Data
(60) Provisional application No. 61/726,235, filed on Nov. 14, 2012.
(60) Provisional application No. 61/789,365, filed on Mar. 15, 2013.

(51) Int. Cl. G01N 21/81; G01W 1/11; G01N 31/22

(52) U.S. Cl. CPC G01N 21/81; G01N 31/22; G01W 1/11

(57) ABSTRACT

Colorimetric moisture-indicating compositions comprising a modified moisture-indicating composition comprising (a) a moisture-indicating composition comprising (1) a solid support and (2) a bis(glyoxime)-transition metal complex bound to the solid support, and (b) a modifier comprising at least one hygroscopic salt are described. In some embodiments, the at least one hygroscopic salt is in physical contact with or in fluid communication with the moisture-indicating composition and comprises an anion the group comprising halide, nitrate, acetate, carbonate, and hydroxide; and a cation selected from the group comprising ammonium, an alkali metal, an alkaline earth metal, and a transition metal. These color-imetric moisture-indicating compositions can be used to make a colorimetric relative humidity-indicating sensor. A method of adjusting the colorimetric response of a colorimetric moisture-indicating composition and a method of detecting moisture are also provided. Colorimetric moisture indicating cards comprising the colorimetric moisture-indicating compositions are also provided.

### FIELD

The present disclosure relates to colorimetric moisture indicators that include moisture-indicating compositions comprising bis(glyoxime)-transition metal complexes bound to solid supports that are modified by the addition of hygroscopic salts. Indicator cards comprising moisture-indicating compositions comprising bis(glyoxime)-transition metal complexes bound to solid supports that are modified by the addition of hygroscopic salts are also included. Methods of adjusting the colorimetric response of moisture indicators based on bis(glyoxime)-transition metal complexes bound to solid supports are also included.

### BACKGROUND

Moisture indicators are used, for example, to determine the amount of moisture or humidity in the vicinity of the indicator. Colorimetric indicators change color upon exposure to moisture or humidity. Current commercialized colorimetric moisture indicators are based on cobalt-containing compounds (e.g., CoCl₂). Alternatives to cobalt compounds are currently being pursued due to the potential adverse environmental impact and expense of cobalt. Other compositions, such as gel supports that include iron (II), iron (III), or copper chloride salts have also been used as moisture indicators, but these indicators do not show strong absorptions in the visible electromagnetic spectrum and the moisture-indicating color change is often difficult to detect.

Additionally, many colorimetric moisture indicators exhibit the moisture-sensitive color change at only one or two specific moisture levels, limiting each indicator's application. For example, some colorimetric moisture indicators express a color change at 60% relative humidity. Some applications where moisture indication is used require the indicators to be sensitive to higher or lower levels of relative humidity. For example, electronics and electronic devices can be very sensitive to moisture, even at low levels of relative humidity, such as below 40% relative humidity, and even below 10% relative humidity.

### SUMMARY

There is a need for economic colorimetric moisture indicators that are not based on cobalt. There is also a need for colorimetric moisture indicators that have a highly visible color change across a wide range of humidity levels, particularly relative humidity levels below 40% relative humidity, and even below 10% relative humidity, and that can change qualitatively and/or quantitatively with a change in humidity.

In one aspect of the present disclosure, a composition is provided that includes a colorimetric moisture-indicating composition comprising a modified moisture-indicating composition. The modified moisture-indicating composition comprises: (a) a moisture-indicating composition comprising (1) a solid support, and (2) a bis(glyoxime)-transition metal complex bound to the solid support, and (b) a modifier comprising at least one hygroscopic salt. The at least one hygroscopic salt comprises an anion selected from the group comprising halide, nitrate, acetate, carbonate, and hydroxide, and comprises a cation selected from the group comprising ammonium, an alkali metal, an alkaline earth metal, and a transition metal. The modifier is in physical contact with or in fluid communication with the moisture-indicating composition.

In another aspect of the present disclosure, a colorimetric relative humidity indicating sensor is provided that comprises a modified moisture-indicating composition. The modified moisture-indicating composition comprises (a) a moisture-indicating composition comprising (1) a solid support, and (2) a bis(glyoxime)-transition metal complex bound to the solid support, and (b) a modifier comprising at least one hygroscopic salt. The at least one hygroscopic salt comprises an anion selected from the group comprising halide, nitrate, acetate, carbonate, and hydroxide, and comprises a cation selected from the group comprising ammonium, an alkali metal, an alkaline earth metal, and a transition metal. The modifier is in physical contact with or in fluid communication with the moisture-indicating composition, and the optical spectrum of the sensor changes quantitatively according to the relative humidity within the environment within which the sensor is placed.

In another aspect, a method of adjusting the colorimetric response of a moisture-indicating composition is provided. The method comprises combining a moisture-indicating composition having a first critical relative humidity with at least one hygroscopic salt having a second critical relative humidity that differs from the first critical relative humidity to make a modified moisture-indicating composition. The moisture-indicating composition comprises a solid support and a bis(glyoxime)-transition metal complex bound to the solid support. The at least one hygroscopic salt is in physical contact with or in fluid communication with the moisture-indicating composition, comprises an anion selected from the group comprising halide, nitrate, acetate, carbonate, and hydroxide, and comprises a cation selected from the group comprising ammonium, an alkali metal, an alkaline earth metal, and a transition metal. The critical relative humidity of the modified moisture-indicating composition differs from the critical relative humidity of the moisture-indicating composition.

In another aspect of the invention, colorimetric moisture-indicating cards comprising a modified colorimetric moisture-indicating composition is provided.

The compositions, sensors, and methods herein can provide highly visible color change across a wide range of humidity levels, particularly relative humidity levels below 40% relative humidity, and even below 10% relative humidity, and can provide qualitative and/or quantitative indications of the amount of moisture in the vicinity of the compositions and sensors.

The above summary is not intended to describe each disclosed embodiment of every implementation of the present invention. The details of one or more embodiments of the invention are also set forth in the description below. Other features, objects, and advantages of the invention will be apparent from the description and from the claims.

### BRIEF DESCRIPTION OF DRAWINGS

FIG. 1 is a perspective view of a colorimetric moisture-indicating card according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

As used herein:

“Bis(glyoxime)-transition metal complex” refers to a complex that has two glyoxime moieties complexed to a transition metal; as described further herein, the glyoxime moieties may have alkyl or other groups substituted for hydrogen at the ortho positions.

“Glyoxime” refers to vicinal dioximes of substituted or unsubstituted orthoketones;

“Hue” ranges in value from 0 to 360 (including all numbers in between), and refers to the degree to which a stimulus can be described as similar to or different from stimuli that are described as red, green, and blue and can be calculated using known mathematical techniques described further herein.

“Humidity” and “moisture” are used interchangeably.

“Visible spectroscopic reflection color intensity change” refers to the difference observed between two color states and in some embodiments can be expressed as difference in Hue.

“Visible spectroscopic reflection” refers to measurements of reflections that are typically in the near UV-visible region of the electromagnetic spectrum—from about 350 nm to about 830 nm; it is understood that the actual reflection spectrum of a particular composition may be influenced by solvent, solvation, interference of thin surface coatings, and other environmental parameters such as temperature.

“Optical spectrum” refers to the spectrum of reflected and/or transmitted electromagnetic radiation in the near visible and visible wavelengths from and/or through an object. In some cases, the change in optical spectrum is a visible color change.

“Transition metal” refers to any element or elements having atomic numbers from 21-30, 39-48, 72-80, and 104-112. Exemplary transition metals include zirconium, titanium, rhodium, iridium, platinum, palladium, gold, nickel, copper, and combinations thereof.

Unless otherwise specified, as used herein, all relative humidity values and critical relative humidity values refer to relative humidity and critical relative humidity, respectively, as measured at room temperature (between 22° C. and 28° C.

Current commercially available humidity indicators rely on inorganic salts such as cobalt (II) chloride to provide visual indication by color intensity change upon exposure to various levels of relative humidity. Recently, cobalt (II) chloride has come under regulatory scrutiny due to environmental concerns. Another problem with the use of cobalt salts for humidity indication is that the color intensity change (for example, blue to pink for cobalt (II) chloride) can be difficult to ascertain, and hence it can be difficult to determine the humidity exposure level.

Humidity indicators can be useful in quantifying relative humidity levels inside sealed packaging. This can be especially important in packaging of electronic components and devices because the viability and performance of these devices and components can be compromised by humidity. For example, the joint industry standard for packaging certain moisture-sensitive devices (IPC/JEDEC J-STD-033B.1) requires that the packaging contain moisture indicators that provide indication of relative humidity levels of 5%, 10%, and 60% relative humidity. Thus, for some applications, there is a need for humidity indicators that can quantify relative humidity levels at or below 5% and 10% relative humidity.

Compositions that include a solid support and a bis(glyoxime)-transition metal complex bound to the support can be a useful alternative to cobalt (II) chloride for colorimetric moisture or humidity determination. Depending upon composition, humidity sensors based on bis(glyoxime)-transition metal complex bound to a solid support can be constructed which can quantitatively determine the humidity level of the atmosphere to which the sensor is exposed. Such humidity sensors can also be constructed to provide reversible or irreversible humidity indication. However, many moisture indicators based on bis(glyoxime)-transition metal complex bound to a solid support show a sharp color change at relative humidities around 60%. In order to extend the application of moisture indicators based on bis(glyoxime)-transition metal complex bound to a solid support, particularly for low relative humidity applications, such as those at or below 5% and 10% relative humidity, the relative humidity at which the sharp color change occurs must to be adjustable across a wide range of humidity conditions.

Provided herein are colorimetric moisture-indicating compositions and sensors based on moisture-indicating compositions comprising bis(glyoxime)-transition metal complexes bound to solid supports and modified by combination with hygroscopic salts. The compositions and sensors can provide qualitative and quantitative detection of moisture across a wide range of relative humidity conditions, such as relative humidities ranging from about 3% to about 80% relative humidity at 25° C. Also provided herein are methods of adjusting the colorimetric response of a moisture-indicating composition based on bis(glyoxime)-transition metal complexes bound to solid supports.

The solid supports used in the compositions, sensors, and methods described herein generally include supports that allow bonding of bis(glyoxime)-transition metal complexes. By bonding it is meant that there is an attractive interaction between the bis(glyoxime)-transition metal complex and the solid support. The attractive interaction can include covalent bonds, ionic bonds, dative bonds, metallic bonds, hydrogen bonds, van der Waals forces, electrostatic forces, chemisorption, physisorption, or any other interaction that attracts the bis(glyoxime)-transition metal complex to the solid support. For example, when a bis(glyoxime)-transition metal complex that is insoluble in water or slightly soluble in water is bound to a solid support, it is typically not removed by successive or continuous rinsing with water. In some embodiments, the attractive interaction includes hydrogen bonds.

While any suitable solid support can be used, some exemplary solid supports include solid metal oxide support, solid inorganic non-metal oxide supports, and solid organic polymeric supports. In some embodiments the solid supports may comprise beads, pellets, spheres, granules, extrudates, tablets, nanoparticles, fibers, rods, needles, wovens, or non-wovens. In some embodiments, the solid support may be in film form, such as coatings and free-standing films.

In some embodiments, compositions are provided that include solid metal oxide supports. The solid metal oxide supports can be relatively colorless (e.g. clear, white, etc.) and capable of adsorbing or bonding to chromophoric species. In some embodiments, the provided solid metal oxide supports include oxides of silicon, aluminum, zirconium, titanium, or combinations thereof. Non-limiting examples of suitable metal oxides include silicon oxide, aluminum oxide, tin oxide, zinc oxide, titanium oxide, zirconium oxide, lanthanide (“rare-earth”) oxides, and mixtures thereof. Metal oxide supports can also include inorganic polymers (geopolymers) formed by reaction of a reactive solid aluminosilicate source such as a dehydroxylated clay with alkali silicate solution, such as those described in MacKenzie et al., Materials Letters, 63, 230-232 (2009). In some embodiments, the provided solid metal oxide supports can include alumina or silica gels, beads, or solid supports. Other exemplary metal oxide supports include zirconium oxide pellets and titanium (IV) oxide pellets.

In some embodiments, compositions are provided that include solid inorganic non-metal-oxide supports. Inorganic non-metal-oxide supports include inorganic solids having a polyatomic, oxygen-containing anion as identified in its crystal structure. In some embodiments, the inorganic non-metal-oxide supports are insoluble or only slightly soluble in water. In some embodiments, the inorganic non-metal-oxide supports have a solubility product (Ksp) value no greater than 1×10⁻³. Exemplary solid inorganic non-metal-oxide supports include phosphate, carbonate, sulfate, and hydroxide supports. In some embodiments, the non-metal-oxide inorganic support can include anhydrous calcium sulfate, zinc carbonate hydroxide, or calcium phosphate.

In some embodiments, compositions are provided that include solid organic polymeric supports. In general, hydrophilic polymers that have the ability to bind transition metal ions and their bis(glyoxime) complexes may be used. In some embodiments, ion exchange polymers having exchangeable ions bound to the polymer may be used. Herein, ion exchange generally refers to the exchange of ions attached to the polymer with the transition metal ions of the bis(glyoxime) transition metal complexes described herein. In some embodiments, solid organic polymeric supports may include polymers with functional groups capable of binding transition metal ions such as sulfonates, phosphates, and carboxylates. Suitable organic polymers may be natural or synthetic. Some exemplary organic polymeric supports include polyamides, polycarbonates, polyalkylene glycols, polyvinyl alcohols, polyvinyl ethers, alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, and cellulose sulphate sodium salt.

In some embodiments, the solid organic polymeric support is a strong acid cation exchange resin. As used herein, the term “strong acid” refers to an acidic group that dissociates completely in water. Strong acids typically have a pKa less than 4 or 5. The strong acid cation exchange resins typically have ionic groups such as sulfonic acid groups (—SO3H), phosphonic acid groups (—PO3H2)), or salts thereof. When present as a salt, the sulfonic acid groups are present as sulfonate anions and the phosphonic acid groups are present as phosphonate anions. Suitable salts often have cations selected from an alkali metal ion (e.g., sodium ion, lithium ion, or potassium ion), an alkaline earth metal ion (e.g., calcium or magnesium), an ammonium ion, or an ammonium ion substituted with one or more alkyl groups, aryl groups, or combinations thereof.

The cation exchange resins are typically crosslinked polymeric materials prepared from various ethylenically unsaturated monomers. The polymeric materials are usually based mainly on styrene, derivatives of styrene (e.g., alpha-methyl styrene), (meth)acrylates, or combinations thereof. The polymeric materials are typically crosslinked to provide the needed amount of rigidity. The cation exchange resins can be in the form of beads, films, fibers, or any other desired form.

In some embodiments, the cation exchange resins are polymeric materials prepared from styrene or derivatives of styrene. Divinyl benzene is commonly used as a crosslinker. The acidic groups can be introduced during the polymerization process by the inclusion of a monomer having an acidic group. Suitable monomers with an acidic group include, for example, 4-stryrene sulfonic acid, vinylsulfonic acid, or a salt thereof in the monomer mixture. Alternatively, the acidic group can be introduced after the polymerization process by treating the polymeric material with a sulfonating agent.

In other embodiments, the cation exchange resins are based on polymeric materials prepared from (meth)acrylate monomers. Monomers with multiple (meth)acryloyl groups can be used as a crosslinker. The acidic group can be introduced during the polymerization process by the inclusion of a monomer having a sulfonic acid group (e.g., N-acrylamidomethanesulfonic acid, 2-acrylamidoethanesulfonic acid, 2-acrylamido-2-methylpropanesulfonic acid, and 2-methacrylamido-2-methylpropanesulfonic acid, or a salt thereof) or by inclusion of a monomer having a phosphonic acid group (e.g., 2-acrylamidoethylphosphonic acid and 3-methacrylamidopropylphosphonic acid, or a salt thereof) Suitable (meth)acrylate-based strong cation exchange resins are further described in U.S. Pat. No. 7,098,253 (Rasmussen et al.), U.S. Pat. No. 7,683,100 (Rasmussen et al.), and U.S. Pat. No. 7,674,835 (Rasmussen et al.).

Strong acid cation exchange resins are commercially available from multiple suppliers. Examples include the cation exchange resins commercially available from Dow Chemical (Midland, Mich.) under the trade designation AMBERLYST (e.g., AMBERLYST 15, AMBERLYST 35, AMBERLYST 40, and AMBERLYST 70), under the trade designation DOWEX (e.g., DOWEX MARATHON and DOWEX MONOSPHERE), under the trade designation AMBERJET (e.g., AMBERJET 1000H), and under the trade designation AMBERLITE (e.g., AMBERLITE IR120H).

The strong acid cation exchange resin can be a gel-type resin or macroporous (i.e., macroreticular) resin. As used herein, the term “macroporous” refers to particles that have a permanent porous structure even in the dry state. Although the resins can swell when contacted with a solvent, swelling is not needed to allow access to the interior of the particles through the porous structure. In contrast, gel-type resins do not have a permanent porous structure in the dry state but must be swollen by a suitable solvent to allow access to the interior of the particles. In many embodiments, the strong acid cation exchange resins are macroporous. Macroporous resins tend to have a higher crosslinking density compared to gel-type resins.

The ion exchange capacity of the cation exchange resins if often at least 0.2 equivalents per liter, at least 0.5 equivalent per liter, at least 1 equivalents per liter, or at least 2 equivalents per liter. The capacity is often up to 10 equivalents per liter, up to 8 equivalents per liter, or up to 5 equivalents per liter. The capacity can be, for example, in a range of 0.1 to 10 equivalents per liter, in a range of 0.5 to 10 equivalents per liter, or in a range of 0.5 to 5 equivalents per liter. High capacity is often desired to adsorb more of the transition metal ion that is part of the bis(glyoxime)-transition metal complex onto the cation exchange resin.

Compositions are provided herein with bis(glyoxime)-transition metal complexes, bound to the solid supports. The bis(glyoxime)-transition metal complex includes two glyoxime moieties that form a complex with transition metals. The bis(glyoxime)-transition metal complex generally has the structure of Formula (I):

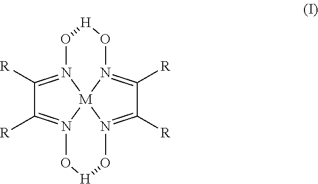

wherein:

M is a transition metal; and

R is independently selected from the groups comprising alkyl, such as ethyl and methyl; aryl, such as phenyl; thioaryl, such as thiophenyl; and a heterocyclic group, such as piperidine and morpholine.

Common glyoxime moieties include dialkylglyoximes such as, for example, dimethylglyoxime and diethylglyoxime. Common glyoximes that may also be useful in the provided compositions include diphenylglyoxime and bis(thiophenyl)glyoxime. Additionally, morpholine and piperidine have been reacted with anti-chloroglyoxime to give morpholineglyoxime and piperidineglyoxime. Since the transition metal ion complexes with the heteroatoms of the glyoxime species (nitrogen and oxygen, for example) it is contemplated that other substituents on the glyoxime molecule may be useful compositions if they do not interfere with the ability of the two glyoxime moieties to complex with a transition metal ion. When complexed, the bis(glyoxime)-transition metal complex typically has a square planar configuration. In some embodiments, the bis(glyoxime)-transition metal complex can include ions of rhodium, iridium, platinum, palladium, gold, nickel or copper which are well known by those of ordinary skill in the art to form square planar coordination complexes with glyoxime moieties like dimethylglyoxime. An exemplary bis(glyoxime)-transition metal complex for use in the moisture-indicating media is nickel dimethylglyoxime. A structure of an exemplary nickel bis(dimethylglyoxime) complex, bis-(dimethylglyoximato) nickel (II), is shown in Formula (II) below:

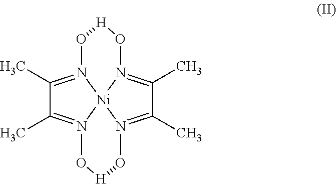

The colorimetric moisture-indicating compositions described herein comprise one or more hygroscopic salts. Hygroscopy of salts generally refers to the ability of the salts to attract, absorb, hold, and transport moisture from the ambient or surrounding environment. The hygroscopic salts may be employed either singly or in a mixture in accordance with the invention. Thus, the term hygroscopic salt refers to single hygroscopic salts or mixtures of more than one hygroscopic salt. In some embodiments, the bis(glyoxime)-transition metal complexes bound to the solid support are mixed with the one or more hygroscopic salts. In some embodiments, the bis(glyoxime)-transition metal complexes bound to the solid support are not mixed with the hygroscopic salts but are placed in fluid communication with the hygroscopic salt or salts. In some embodiments, placing the hygroscopic salt or salts in fluid communication with the bis(glyoxime)-transition metal complexes bound to the solid support can include allowing a layer of the bis(glyoxime)-transition metal complexes bound to the solid support to contact a layer of the hygroscopic salt or salts. In some embodiments, placing the hygroscopic salt or salts in fluid communication with the bis(glyoxime)-transition metal complexes bound to the solid support can include placing a moisture-transferring material between the hygroscopic salt or salts and the bis(glyoxime)-transition metal complexes bound to the solid support. Generally, any hygroscopic salt may be employed in the compositions described herein. In some embodiments, hygroscopic salts may be used that decrease the inherent relative humidity at which the modified moisture-indicating composition expresses sharp color change, as compared to the relative humidity at which the moisture-indicating composition (without modification) expresses sharp color change.

The one or more hygroscopic salts act as a modifier to modify the relative humidity at which the moisture-indicating compositions exhibit color change. In some embodiments, the modified moisture-indicating composition will exhibit a sharp color change at a relative humidity equivalent to the critical relative humidity of the hygroscopic salt used in the composition. Critical relative humidity of a hygroscopic salt generally refers to the relative humidity level in the environment surrounding the hygroscopic salt at which the hygroscopic salt starts to absorb moisture rapidly from the atmosphere in the surrounding environment to form a saturated solution. Methods for measuring critical relative humidity are known in the art, including measuring the equilibrium humidity of a closed chamber containing a saturated salt, measuring weight changes of the salt at different humidity levels, and other known methods.

In some embodiments, the hygroscopic salt is present in the modified moisture-indicating composition in an amount ranging from 1 to 99% by weight of the modified moisture-indicating composition. In some embodiments, the hygroscopic salt is present in an amount ranging from 5 to 95% by weight of the modified moisture-indicating composition. In some embodiments, the hygroscopic salt is present in an amount ranging from 25 to 75% by weight of the modified moisture-indicating composition. The amount of the hygroscopic salt present in the modified moisture-indicating composition will be dependent upon factors such as the specific moisture-indicating composition used, the desired adjustment to the relative humidity at which the modified moisture-indicating composition shows sharp color change, as well as the desired application in which the modified moisture-indicating composition is being used, but can be determined by those skilled in the art.

In some embodiments, the modified moisture-indicating composition will exhibit a sharp color change at a relative humidity that is different from the critical relative humidity of the hygroscopic salt used in the composition. The shift in color or optical spectrum change (as compared to the color or optical spectrum change exhibited by the same bis(glyoxime)-transition metal complexes bound to the same solid support, without the hygroscopic salt) caused by the addition of the hygroscopic salt depends on the type of salt, amount of salt, and the inherent hygroscopicity of the support. In general, the addition of hygroscopic salts results in colorimetric moisture-indicating compositions that exhibit color or optical spectrum changes at lower relative humidities than a similar moisture-indicating composition without the hygroscopic salt. In some embodiments the addition of hygroscopic salts typically shifts the point of color change to lower values of relative humidity, such as relative humidity values below 60%.

In some embodiments, the hygroscopic salt used will have a critical relative humidity at or below 80%. In some embodiments, the hygroscopic salt used will have a critical relative humidity at or below 70%, 60%, or 50%. In some embodiments, the hygroscopic salt used will have a critical relative humidity at or below 40%. In some embodiments, the hygroscopic salt used will have a critical relative humidity ranging from about 3% to about 80%. In some embodiments, the hygroscopic salt used will have a critical relative humidity ranging from about 3% to about 60%, about 3% to about 50%, or about 3% to about 40%.

In some embodiments, the hygroscopic salt comprises an anion selected from the group comprising halide, nitrate, acetate, carbonate, and hydroxide, and comprises a cation selected from the group comprising ammonium, an alkali metal, an alkaline earth metal, and a transition metal. Exemplary hygroscopic salts for use in the compositions described herein include lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

Using the above-identified compositions, colorimetric moisture-indicating sensors can be constructed. The colorimetric moisture-indicating compositions may be made into a multimedia construction in combination with other media and/or containment devices. Exemplary multimedia constructions can include loose-packed indicator constructions (e.g., particles or fibers contained in a vial, packed in a tube, or wrapped in a flexible fabric), loose, non-packed indicator constructions (e.g., physically entangled moisture-indicating media in a fibrous web, such as particle-loaded webs), multilayer constructions (e.g., indicator films on or between additional material layers which may have varying degrees of fluid permeability, or indicator particles or fibers sandwiched between containment layers), or partially embedded or encapsulated constructions (e.g., particles or fibers partially embedded in a polymer, such as an adhesive-coated film or fiber; composites, such as an articulated bulk shape, film, or fiber). In some embodiments, moisture-indicating media particles or fibers may also be contained in a porous matrix. In some embodiments, the colorimetric moisture-indicating composition may be dispersed or dissolved in a solvent.

In some embodiments, the colorimetric moisture-indicating compositions can be attached to, deposited on, physically entangled in, and/or embedded in secondary supports. The secondary supports can be one dimensional (e.g., fiber), two dimensional (e.g., planar substrates such as paper, glass, or polymer films), and three dimensional (e.g., fiber network, sponge structures). The colorimetric moisture-indicating compositions can be attached to the secondary supports by physical adsorption of the mixture to the secondary supports or using adhesives (such as pressure sensitive adhesives) or binding polymers (such as polyvinyl alcohol). In some embodiments, the colorimetric moisture-indicating composition can be deposited on backing material or carrier material to create moisture-indicating sensors in the form of cards and tapes according to conventional methods known in the art. Exemplary backing materials and carrier materials include those made of paper, kraft papers, polyethylene, polypropylene, polyester or composites of any of these materials. In some embodiments, the side of the backing materials and carrier materials opposite the deposited colorimetric moisture-indicating composition can be coated with release agents such as fluorochemicals or silicones. Exemplary tapes may comprise acrylic, urethane, and silicone polymers. In some embodiments, the sensor is structured such that the colorimetric moisture-indicating composition is in fluid communication with the surrounding environment.

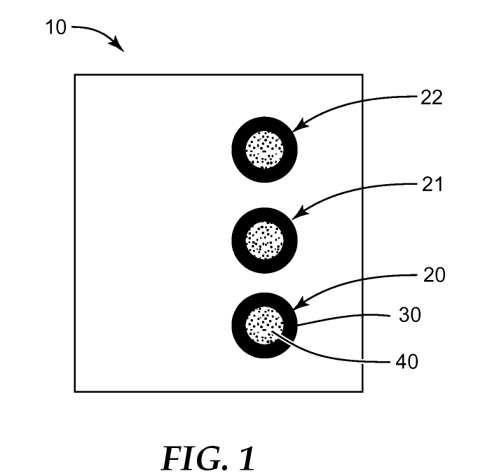

FIG. 1 depicts a perspective view of a colorimetric moisture-indicating card 10 comprising at least one moisture-indicating area 20, 21, 22 comprising an area covered by a colorimetric moisture-indicating composition 40 as described herein. In some embodiments, the colorimetric moisture-indicating 40 composition can be in solid particulate form. The colorimetric moisture-indicating composition 40 may be bound to the moisture-indicating card 10 using adhesives, binders, or other supports. Exemplary adhesives, binders, and support materials are described above. The at least one moisture-indicating area 20, 21, 22 can optionally comprise a color-enhancing area 30 surrounding at least a portion of the colorimetric moisture-indicating composition 40. Alternatively, the colorimetric moisture-indicating composition 40 may be disposed upon the optional color-enhancing area 30. In such cases, the optional color-enhancing area 30 may extend beyond the area covered by the colorimetric moisture-indicating composition 40. The color-enhancing area 30 may comprise ink, dye, or a separate layer made of conventional materials adhered to the moisture-indicating card 10 using conventional methods for adhesion.

In some embodiments, the optional color-enhancing area 30 can have a color similar to the dry state of the moisture-indicating composition 40, wet state of the moisture-indicating composition 40, or another color. In some embodiments, the color-enhancing area is white or black. The color-enhancing areas 30 are located in close proximity to the moisture-indicating composition 40. The role of the color-enhancing area 30 is to provide a clearer visual indication of color change between wet and dry states of the moisture-indicating composition 40.

In some embodiments, each of the at least one moisture-indicating areas 20, 21, 22 on the colorimetric moisture-indicating card 10 can provide colorimetric moisture indication of the same or different relative humidities. For example, in some embodiments, moisture-indicating area 20 may show a sharp color change at a relative humidity of 3%, 5%, 8%, 10%, 20%, or even 40%, while moisture-indicating area 21 may independently show a sharp color change at 5%, 10%, 20%, 40%, 50%, 55%, or even 60%, and moisture-indicating area 22 may show a sharp color change at 40%, 50%, 55%, 60%, 70%, or 80%. In some embodiments, the colorimetric moisture-indicating card 10 may further comprise ink or other components, such as writing, instructions, reference colors, or the like.

In some embodiments, the colorimetric moisture-indicating compositions can be inserted between two secondary supports. In such cases, one of the secondary supports may be visibly transparent enough to allow visual observation the color change of indicators. At least one of the secondary supports should allow the transfer of humidity to the colorimetric moisture-indicating composition. In some embodiments, both of the secondary supports are impermeable to particles.

In some embodiments, the colorimetric moisture-indicating compositions can be contained within transparent or semi-transparent vials or containers that have caps. The caps may optionally comprise filtering layers that are impermeable to particles, but that allow the transfer of humidity across the filters.

The color of the colorimetric moisture-indicating compositions described herein may be observed visually with the human eye, or with the assistance of measuring devices such as a spectrophotometer or a colorimeter. The amount of moisture to which the colorimetric moisture-sensor is exposed can be measured spectroscopically, for example, by reflection. Since the provided colorimetric moisture-indicating compositions are solid, the change in color can be measured by reflecting light off of the surface of the solid and measuring the loss of intensity from wavelengths absorbed by the surface. In some embodiments, the absorbance at a given wavelength can be measured using an optics spectroscopy system that is configured for reflection spectroscopy. An exemplary optics spectroscopy system suitable for this measurement is Model Jaz-EL350, available from Ocean Optics, Dunedin, Fla. Typically, a spectrum from a white piece of paper or white powders can be used as a reference spectrum when measuring reflection intensity.

In some embodiments, the visible spectroscopic reflection intensity in the wavelength range of 460 nm to 560 nm and color can be expressed as the Hue. Hue may be quantitatively related to the level of moisture in the environment within which the colorimetric moisture-indicating composition is located, and may be determined by converting a measured reflection spectrum to Hue using known mathematical techniques as described further herein. In some embodiments, the color, Hue, reflection spectrum, or transmission spectrum of the colorimetric moisture-indicating composition is quantitatively related to the level of moisture (humidity or relative humidity) in the environment in which the colorimetric moisture-indicating composition is located. By quantitatively it is meant that the reflection intensity in the wavelength range of 460 nm to 560 nm and the Hue number, expressed by color, has a one-to-one correlation to the amount of humidity or relative humidity. The environment within which the colorimetric moisture-indicating composition is located can be an area or volume surrounding the colorimetric moisture-indicating composition, including, for example, the area, volume, and/or atmosphere in contact with the colorimetric moisture-indicating composition. In some embodiments, the color, Hue, reflection spectrum, or transmission spectrum of the colorimetric moisture-indicating composition is directly related to the level of moisture (humidity or relative humidity) in an environment. By directly related, it is meant that the property gives information about the level of moisture in the environment within which the colorimetric moisture-indicating composition is located. This information may be approximate, or may be quantitatively related to the level of moisture in the environment within which the colorimetric moisture-indicating composition is located. In some embodiments where color is visually observed to determine the level of moisture, the colorimetric moisture-indicating composition will exhibit a distinct color change with varying moisture conditions. For example, the colorimetric moisture-indicating composition may exhibit two different colors at two different levels of relative humidity, such as appearing green at a relative humidity of 30% and appearing pink at a relative humidity of 70% at 25° C.

The colorimetric moisture-indicating composition can be used in any environment or space, including both enclosed spaces or volumes and unenclosed spaces or volumes. Exemplary environments include enclosed containers, packaging, rooms, etc. In some embodiments, the conditions of temperature and pressure within the environment will be homogeneous. In some embodiments, the conditions of temperature and pressure within the environment will not be homogeneous.

In some embodiments, the colorimetric moisture-indicating compositions described herein can exhibit extended relative humidity response ranges as compared to moisture-indicating composition based solely on bis(glyoxime)-transition metal complexes bound to solid supports alone (without the added hygroscopic salts described herein). In some embodiments, the colorimetric moisture-indicating composition quantitatively changes color, Hue, reflection spectrum, or transmission spectrum at relative humidities ranging from about 3% to about 80% relative humidity at 25° C. In some embodiments, the colorimetric moisture-indicating composition quantitatively changes color, reflection spectrum, or transmission spectrum at relative humidities ranging from about 3% to about 40% relative humidity at 25° C.

In some embodiments, the colorimetric moisture-indicating compositions can be irreversible. By irreversible, it is meant that when the composition is exposed to one set of humidity conditions it has an original value associated with a specific optical spectrum (or Hue, or color). When the set of humidity conditions is changed, the composition changes color to give a different, second value associated with a specific optical spectrum (or Hue, or color). And, when the composition is returned to the initial set of humidity conditions, the optical spectrum (or Hue, or color) does not return to the original optical spectrum (or Hue, or color).

In some embodiments, the colorimetric moisture-indicating compositions can be reversible. By reversible it is meant that when the composition is exposed to one set of humidity conditions it has an original value associated with a specific optical spectrum (or Hue, or color). When the set of humidity conditions is changed, the composition changes color to give a different, second value associated with a specific optical spectrum (or Hue, or color); and, finally, when the composition is returned to the initial set of humidity conditions, the composition changes again, resulting in a third value associated with a specific optical spectrum (or Hue, or color). That resulting third value returns to approximately the original value. In some embodiments, the moisture-indicating compositions will exhibit complete reversibility. Such reversible moisture-indicating compositions substantially return to the original value of the specific optical spectrum (or Hue, or color) when re-exposed to the initial set of humidity conditions. Thus, for completely reversible colorimetric moisture-indicating compositions, the third value of the specific optical spectrum (or Hue, or color) is substantially equivalent to the original value of the specific optical spectrum (or Hue, or color). In other embodiments, the colorimetric moisture-indicating compositions will exhibit partial reversibility, i.e., when the composition is returned to the initial set of humidity conditions, the resulting third value of the specific optical spectrum (or Hue, or color) is closer to the original value than to the second value. For example, when the solid metal oxide support is aluminum oxide, silicon oxide, or a combination thereof, and when the bis(glyoxime)-transition metal complex includes nickel and two dimethylglyoxime moieties (the complex shown in Formula (II)) a reversible moisture-indicating composition can be formed.

In some embodiments, the color changes are easily detectable with the human eye. In these embodiments, the human eye can detect the difference between the original value and the second value of the color (or Hue), as well as the difference between the second value and the third value of the color (or Hue). Thus, in some embodiments the difference between the original Hue number and the second Hue number, or the difference between the second Hue number and the third Hue number is at least 15, in some embodiments at least 30, and in some embodiments at least 60. In some color ranges, such as between Hue numbers of 0 and 60, or Hue numbers of 300 and 360, smaller differences in Hue are detectable with the human eye. In other color ranges, such as between Hue numbers of 60 and 300, only larger differences in Hue number may be detectable with the human eye. It is not necessary that the difference between the original value and the third value of the color (or Hue), if any, is detectable by the human eye.

Also provided is a method of adjusting the colorimetric response of a moisture-indicating composition. The moisture-indicating composition can include moisture indicators based on bis(glyoxime)-transition metal complexes bound to solid supports. The method can comprise the steps of combining a moisture-indicating composition having a first critical relative humidity with at least one hygroscopic salt having a second critical relative humidity that differs from the first critical relative humidity to make a modified moisture-indicating composition. The moisture-indicating composition comprises a solid support and a bis(glyoxime)-transition metal complex bound to the solid support. The at least one hygroscopic salt is in physical contact with or in fluid communication with the moisture-indicating composition, comprises an anion selected from the group comprising halide, nitrate, acetate, carbonate, and hydroxide, and comprises a cation selected from the group comprising ammonium, an alkali metal, an alkaline earth metal, and a transition metal. The critical relative humidity of the modified moisture-indicating composition differs from the critical relative humidity of the moisture-indicating composition (without the hygroscopic salt). Exemplary solid supports, bis(glyoxime)-transition metal complexes, and hygroscopic salts used in the method include those described herein.

Also provided is a method of detecting moisture. The method includes providing a composition that includes a modified moisture-indicating composition. The modified moisture-indicating composition comprises (a) a moisture-indicating composition comprising (1) a solid support and (2) a bis(glyoxime)-transition metal complex bound to the support, and (b) a hygroscopic salt. The method further includes exposing the modified moisture-indicating composition to a moist atmosphere. The provided method further includes observing the color of the composition and/or measuring the visible spectroscopic reflection spectrum of the composition after exposing it to a moist atmosphere.

Following are exemplary embodiments of a bis(glyoxime)-transition metal complexes and moisture indicators made therewith according to aspects of the present invention.

Embodiment 1 is a colorimetric moisture-indicating composition comprising a modified moisture-indicating composition comprising (a) a moisture-indicating composition comprising (1) a solid support and (2) a bis(glyoxime)-transition metal complex bound to the solid support, and (b) a modifier comprising at least one hygroscopic salt, wherein the at least one hygroscopic salt comprises an anion selected from the group comprising halide, nitrate, acetate, carbonate, and hydroxide; wherein the at least one hygroscopic salt comprises a cation selected from the group comprising ammonium, an alkali metal, an alkaline earth metal, and a transition metal; and wherein the modifier is in physical contact with or in fluid communication with the moisture-indicating composition.

Embodiment 2 is a colorimetric moisture-indicating composition according to embodiment 1, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

Embodiment 3 is a colorimetric moisture-indicating composition according to any of the preceding embodiments, wherein the at least one hygroscopic salt has a critical relative humidity ranging from about 3% to about 80% relative humidity at 25° C.

Embodiment 4 is a colorimetric moisture-indicating composition according to any of the preceding embodiments, wherein the at least one hygroscopic salt has a critical relative humidity ranging from about 3% to about 60% relative humidity at 25° C.

Embodiment 5 is a colorimetric moisture-indicating composition according to any of the preceding embodiments, wherein the at least one hygroscopic salt has a critical relative humidity ranging from about 3% to about 50% relative humidity at 25° C.

Embodiment 6 is a colorimetric moisture-indicating composition according to any of the preceding embodiments, wherein the at least one hygroscopic salt has a critical relative humidity of from about 3% to about 40% relative humidity at 25° C.

Embodiment 7 is a colorimetric moisture-indicating composition according to any of the preceding embodiments, wherein the solid support comprises an inorganic support.

Embodiment 8 is a colorimetric moisture-indicating composition according to any of the preceding embodiment, wherein the inorganic support comprises a metal oxide.

Embodiment 9 is a colorimetric moisture-indicating composition according to embodiment 8, wherein the metal oxide comprises an oxide of aluminum, silicon, or a combination thereof.

Embodiment 10 is a colorimetric moisture-indicating composition according to embodiment 8, wherein the metal oxide comprises an oxide of zirconium, titanium, or a combination thereof.

Embodiment 11 is a colorimetric moisture-indicating composition according to embodiment 7, wherein the inorganic support comprises at least one of a sulfate, a carbonate, and a phosphate.

Embodiment 12 is a colorimetric moisture-indicating composition according to any one of embodiments 1-6, wherein the solid support comprises an organic polymeric support.

Embodiment 13 is a colorimetric moisture-indicating composition according to embodiment 12, wherein the organic polymeric support is an ion exchange polymer.

Embodiment 14 is a colorimetric moisture-indicating composition according to any one of embodiments 12-13, wherein the organic polymeric support is a cation exchange polymer.

Embodiment 15 is a colorimetric moisture-indicating composition according to any of the preceding embodiments, wherein the transition metal in the bis(glyoxime)-transition metal complex comprises rhodium, iridium, platinum, palladium, gold, nickel, copper, or a combination thereof.

Embodiment 16 is a colorimetric moisture-indicating composition according to any of the preceding embodiments, wherein the bis(glyoxime)-transition metal complex comprises bis(dimethylglyoximato)-nickel (II).

Embodiment 17 is a colorimetric relative humidity-indicating sensor comprising a modified moisture-indicating composition comprising (a) a moisture-indicating composition comprising (1) a solid support and (2) a bis(glyoxime)-transition metal complex bound to the solid support, and (b) a modifier comprising at least one hygroscopic salt; wherein the at least one hygroscopic salt comprises an anion selected from the group comprising halide, nitrate, acetate, carbonate, and hydroxide; wherein the at least one hygroscopic salt comprises a cation selected from the group comprising ammonium, an alkali metal, an alkaline earth metal, and a transition metal; wherein the modifier is in physical contact with or in fluid communication with the moisture-indicating composition; and wherein the optical spectrum of the moisture-indicating sensor changes quantitatively according to the relative humidity within the environment within which the sensor is placed.

Embodiment 18 is a sensor according to embodiment 17, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

Embodiment 19 is a sensor according to any one of embodiments 17-18, wherein the bis(glyoxime)-transition metal complex comprises bis(dimethylglyoximato)-nickel (II).

Embodiment 20 is a sensor according to any one of embodiments 17-19, wherein the transition metal in the bis(glyoxime)-transition metal complex comprises rhodium, iridium, platinum, palladium, gold, nickel, copper, or a combination thereof.

Embodiment 21 is a sensor according to any one of embodiments 17-20, wherein the solid support comprises an inorganic support.

Embodiment 22 is a sensor according to embodiment 21, wherein the inorganic support comprises a metal oxide.

Embodiment 23 is a sensor according to embodiment 22, wherein the metal oxide comprises an oxide of aluminum, silicon, or a combination thereof.

Embodiment 24 is a sensor according to embodiment 22, wherein the metal oxide comprises an oxide of zirconium, titanium, or a combination thereof.

Embodiment 25 is a sensor according to embodiment 21, wherein the inorganic support comprises at least one of a sulfate, a carbonate, and a phosphate.

Embodiment 26 is a sensor according to any one of embodiments 17-20, wherein the solid support comprises an organic polymeric support.

Embodiment 27 is a sensor according to embodiment 26, wherein the organic polymeric support is an ion exchange polymer.

Embodiment 28 is a sensor according to any one of embodiments 26-27, wherein the organic polymeric support is a cation exchange polymer.

Embodiment 29 is a sensor according to any one of embodiments 17-28, wherein the sensor quantitatively changes optical spectrum at relative humidities ranging from about 3% to about 80% relative humidity at 25° C.

Embodiment 30 is a sensor according to any one of embodiments 17-29, wherein the sensor quantitatively changes optical spectrum at relative humidities ranging from about 3% to about 60% relative humidity at 25° C.

Embodiment 31 is a sensor according to any one of embodiments 17-30, wherein the sensor quantitatively changes optical spectrum at relative humidities ranging from about 3% to about 50% relative humidity at 25° C.

Embodiment 32 is a sensor according to any one of embodiments 17-31, wherein the sensor quantitatively changes optical spectrum at relative humidities ranging from about 3% to about 40% relative humidity at 25° C.

Embodiment 33 is a sensor according to any one of embodiments 17-32, wherein the modified moisture-indicating composition is attached to a secondary support.

Embodiment 34 is a method of adjusting the colorimetric response of a moisture-indicating composition comprising combining a moisture-indicating composition having a first critical relative humidity with at least one hygroscopic salt having a second critical relative humidity that differs from the first critical relative humidity to make a modified moisture-indicating composition; wherein the at least one hygroscopic salt is in physical contact with or in fluid communication with the moisture-indicating composition; wherein the moisture-indicating composition comprises a solid support and a bis(glyoxime)-transition metal complex bound to the solid support; wherein the at least one hygroscopic salt comprises an anion selected from the group comprising halide, nitrate, acetate, carbonate, and hydroxide; wherein the at least one hygroscopic salt comprises a cation selected from the group comprising ammonium, an alkali metal, an alkaline earth metal, and a transition metal; and wherein the critical relative humidity of the modified moisture-indicating composition differs from the critical relative humidity of the moisture-indicating composition.

Embodiment 35 is a method according to embodiment 34, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

Embodiment 36 is a method according to any one of embodiments 34-35, wherein the bis(glyoxime)-transition metal complex comprises bis(dimethylglyoximato)-nickel (II).

Embodiment 37 is a method according to any one of embodiments 34-36, wherein the transition metal in the bis(glyoxime)-transition metal complex comprises rhodium, iridium, platinum, palladium, gold, nickel, copper, or a combination thereof.

Embodiment 38 is a method according to any one of embodiments 34-37, wherein the solid support comprises an inorganic support.

Embodiment 39 is a method according to embodiment 38, wherein the inorganic support comprises a metal oxide.

Embodiment 40 is a method according to embodiment 39, wherein the metal oxide comprises an oxide of aluminum, silicon, or a combination thereof.

Embodiment 41 is a method according to embodiment 39, wherein the metal oxide comprises an oxide of zirconium, titanium, or a combination thereof.

Embodiment 42 is a method according to embodiment 38, wherein the inorganic support comprises at least one of a sulfate, a carbonate, and a phosphate.

Embodiment 43 is a method according to any one of embodiments 34-37, wherein the solid support comprises an organic polymeric support.

Embodiment 44 is a method according to embodiment 43, wherein the organic polymeric support is an ion exchange polymer.

Embodiment 45 is a method according to any one of embodiments 43-44, wherein the organic polymeric support is a cation exchange polymer.

Embodiment 46 is a method according to any one of embodiments 34-45, wherein the sensor quantitatively changes optical spectrum at relative humidities ranging from about 3% to about 80% relative humidity at 25° C.

Embodiment 47 is a method according to any one of embodiments 34-46, wherein the sensor quantitatively changes optical spectrum at relative humidities ranging from about 3% to about 60% relative humidity at 25° C.

Embodiment 48 is a method according to any one of embodiments 34-47, wherein the sensor quantitatively changes optical spectrum at relative humidities ranging from about 3% to about 50% relative humidity at 25° C.

Embodiment 49 is a method according to any one of embodiments 34-48, wherein the sensor quantitatively changes optical spectrum at relative humidities ranging from about 3% to about 40% relative humidity at 25° C.

Embodiment 50 is a method according to any one of embodiments 34-49, wherein the modified moisture-indicating composition is attached to a secondary support.

Embodiment 51 is a method of detecting moisture comprising providing a colorimetric moisture-indicating composition that comprisies (a) a modified moisture-indicating composition comprising (1) a solid support and (2) a bis(glyoxime)-transition metal complex bound to the support, and (b) a hygroscopic salt; exposing the composition to a moist atmosphere; and determining the level of moisture within the moist atmosphere.

Embodiment 52 is a method according to embodiment 51, wherein determining the level of moisture comprises visually observing the color of the colorimetric moisture-indicating composition after exposing it to a moist atmosphere.

Embodiment 53 is a method according to any one of embodiments 51-52, wherein determining the level of moisture comprises measuring the visible spectroscopic reflection spectrum of the colorimetric moisture-indicating composition after exposing it to a moist atmosphere.

Embodiment 54 is colorimetric moisture-indicating card comprising a colorimetric moisture-indicating composition according to any one of Embodiments 1-16.

Embodiment 55 is a colorimetric moisture-indicating card comprising a modified moisture-indicating composition comprising:
a moisture-indicating composition comprising
   a solid support; and
   a bis(glyoxime)-transition metal complex bound to the solid support; and
a modifier comprising at least one hygroscopic salt,

wherein the at least one hygroscopic salt comprises an anion selected from the group comprising halide, nitrate, acetate, carbonate, and hydroxide; and

wherein the at least one hygroscopic salt comprises a cation selected from the group comprising ammonium, an alkali metal, an alkaline earth metal, and a transition metal; and

wherein the modifier is in physical contact with or in fluid communication with the moisture-indicating composition.

Objects and advantages of this invention are further illustrated by the following examples, but the particular materials and amounts thereof recited in these examples, as well as other conditions and details, should not be construed to unduly limit this invention.

### EXAMPLES

All percentages and ratios are by weight unless otherwise specified.

As used in these examples, the term “indicator compositions” is used to refer to any of the moisture-indicating compositions, the modified moisture-indicating compositions, and the colorimetric moisture-indicating compositions. The indicator compositions are shown in these examples as: transition metal/(bis)glyoxime/solid support (e.g., Ni²⁺/dimethylglyoxime/Al₂O₃ microbeads), such as in the case of the moisture-indicating compositions, or the hygroscopic salt/transition metal/(bis)glyoxime/solid support (e.g. Salt/Ni²⁺/dimethylglyoxime/SiO₂ microbeads or MgCl₂/Ni²⁺/dimethylglyoxime/SiO₂ microbeads), such as in the case of the modified moisture-indicating compositions.

As used in these examples, each change in the level of relative humidity indicates a step change in 10% increments, unless specified otherwise.

### Test Methods and Preparatory Methods

### Humidity Controlled Air

A test assembly was used to humidify and deliver humidified air to a mixing chamber where it was mixed with dry air to provide humidified air controlled to the step changes in percent relative humidity (%RH) detailed in the examples. The controlled humidity air (%RH±1%) was delivered to a test chamber where a moisture indicator was tested.

Air was humidified in a water jacketed 500 mL 3-neck round-bottom flask controlled to 35.5° C. or 29° C. with a heating/cooling circulator (Model 1160S from VWR). The flask contained about 250 mL of distilled water. Dry air was flowed through tubing from a flow meter into the inlet neck of the flask to evaporate water. The middle neck was fitted with a thermometer. The exit neck of the flask was connected by tubing to the inlet of a 3-neck flask that served as a mixing chamber. Dry air was flowed into the mixing chamber and mixed with the humid air to the desired relative humidity for testing. The humidified air was then flowed into a test chamber. Gas flow regulators (Matheson, Basking Ridge, N.J.) were used to control the flow of the air streams through the apparatus at about 7.5 liters/minute. TEFLON tubing was used throughout the system. The humidity and temperature were monitored and recorded with a humidity meter (iTHX-M Humidity Meter, Omega Engineering Inc., Stamford, Conn.). The measured temperature was usually around 23±0.7° C.

The test chamber was prepared with two glass plates (approximately 7.5 cm×10 cm) separated by two rubber sheets (approximately 7.5 cm×10 cm×0.7 cm) that had 2.5 cm×7.5 cm cutouts in the center forming a chamber. A 0.6 cm opening on the top glass plate at one end of the chamber was used to deliver controlled humidity air to the test chamber and air flowed out of a second 0.6 cm opening on the other end of chamber to the humidity meter.

### Preparation of an Indicator Tape for Testing

Various indicator compositions were tested for optoelectronic measurements in the form of an indicator tape. The tape was prepared by placing approximately 20 mg of an indicator composition on a 1 cm×1 cm square piece of #1 Whatman filter paper. The indicator composition was covered by a 1 cm by 3 cm strip of clear adhesive tape (Scotch® Premium Transparent Film Tape 600 Clear, 3M Company, St. Paul, Minn.) and the outer edges of the paper were sealed to the tape to encapsulate the indicator composition to form the indicator tape. The exposed adhesive portions of the tape were covered with a plastic film to facilitate handling. The indicator tape was suspended across the opening on the top rubber sheet with the paper side facing the inside of the chamber and the tape side against the top glass plate so that controlled humidity air flowing into the chamber contacted the indicator composition through the permeable filter paper.

### Optoelectronic Measurement Method

The color changes of indicator compositions were observed using a spectroscopy system. One end of a reflection optical probe (Model QR400-7-UV-VIS, obtained from Ocean Optics; Dunedin, Fla.) was connected to a light source (Model HL-2000-FHSA, Ocean Optics) and the other to a spectrometer (Jaz-EL350, Ocean Optics). The probe was located above the indicator composition in the test chamber to measure reflection spectra. A spectrum from white alumina microbeads (AG™7, 100-200 mesh microbeads, BioRad Laboratories) was taken for a reference spectrum for reflection intensity. The wavelength range of spectra was from 340.58 nm to 1031.1 nm. A plot of reflection intensity (%) versus wavelength was generated for each % RH test condition.

The obtained reflection spectrum was converted to color, i.e., RGB color space, as follows. The measured reflection spectrum was constructed to International Commission on Illumination (or “CIE”) XYZ color space using color matching the CIE 1931 2° Standard Observer function. The CIE XYZ color space was linear transformed to National Television System Committee (NTSC) RGB space using NTSC color space chromaticity coordinates (x_{R}=0.67, y_{R}=0.33. x_{G}=0.21, y_{G}=0.71, X_{B}=0.14, y_{B}=0.08). Then, Hue, one of the main properties of a color, was computed from RGB values. Hue, as defined above, is the degree to which a stimulus can be described as similar to or different from stimuli that are described as red, green, and blue. The color can be correlated to a location (Hue) in the color wheel from 0 degree to 360 degree. The color at 0 degree is equal to that at 360 degrees. All mathematical processing was done by a customized LABVIEW program (software available from National Instruments of Austin, Tex.). The conversion from spectra to Hue was confirmed by measuring spectra from color printed papers with known Hue, calculating Hue from spectra and comparing Hue from spectra with the known Hue of color printed papers. Hues from the spectra were consistent with the known Hues of color printed papers.

Controlled humidity levels at 23° C. and the corresponding reflection spectra were acquired every 10 seconds simultaneously. When Hue from reflection spectra was stabilized at a certain value, i.e., no further change occurred, the next humidity level was applied step by step.

### Materials

Alumina microbeads refers to neutral, non-acidic alumina microbeads (100-200 mesh) commercially available under the trade designation AG7 from BioRad Laboratories (Berkeley, Calif.).
Aqueous KOH refers to a 1 M potassium hydroxide solution prepared with potassium hydroxide (KOH) obtained from BDH/VWR International (West Chester, Pa.).
Dimethylglyoxime was obtained from Mallinckrodt (New York, N.Y.).
KOAc refers to potassium acetate obtained from Sigma Chemical Co. (St. Louis, Mo.).
LiBr refers to lithium bromide obtained from Aldrich Chemical Co., Inc. (Milwaukee, Wis.).
LiCl refers to lithium chloride obtained from MP Biomedicals, LLC (Solon, Ohio).
MgCl₂ refers to magnesium chloride hexahydrate obtained from BDH/VWR International (West Chester, Pa.).
Mg(NO₃)₂ refers to magnesium nitrate hexahydrate obtained from J.T. Baker/Mallinckrodt Baker Inc. (Phillipsburg, N.J.).
NaCl refers to sodium chloride obtained from BDH/VWR International(West Chester, Pa.).
Nickel acetate solution refers to a 5 weight percent (wt %) solution of nickel acetate dissolved in deionized water. The nickel acetate tetrahydrate (Ni(OAc)₂.4H₂O) was obtained from EM Science (Gibbstown, N.J.).
Polymeric beads refers to a strongly acidic, cation exchange resin commercially available under the trade mark AMBERLYST-15 from Sigma-Aldrich (St. Louis, Mo.). The ionic groups are sulfonate groups.
Silica microbeads refers to 150-230 mesh silica microbeads having a surface area of 500-600 m²/g that is commercially available under the trade designation SILICA GEL 60 from Alfa Aesar (Ward Hill, Mass.).

The critical relative humidity of a salt is the % RH of the atmosphere surrounding it at which the salt starts to absorb moisture rapidly and dissolves to form a saturated salt solution. The critical relative humidity of salts at certain temperatures has been reported in the literature in various references including: 1) Trofimenkoff, F. N.; Hedlin, C. P. “Relative Humidities over Saturated Solutions of Nine Salts in the Temperature Range from 0 to 90° F,” International Symposium on Humidity and Moisture, Proceedings, 1963; Volume 3, Chapter 31, pp. 519-520; 2) Greenspan, L. “Humidity Fixed Points of Binary Saturated Aqueous Solutions,” J Res Natl Bur Stand Sect A Phys Chem 1977, 81 A, pp. 89-96; and 3) Daniel, I. O.; Oyekale, K. O.; Ajala, M. O.; Sanni, L. O.; Okelana, M. A.; Adetumbi, J. A.; Akintobi, A. C.; Adebisi, A.; “Moisture Sorption in Commercial Hybrid Maize (Zea mays L.) Seeds During Storage at Ambient Tropical Conditions,” Res. J. Seed Sci. 2012, 5, pp. 32-37.

Table 1 shows the equilibrium relative humidity values for various saturated salt solutions at 25° C., i.e., the critical relative humidity at 25° C., reported in the literature.

TABLE 1
Equilibrium relative humidity of various saturated salt solutions at 25° C.
(critical relative humidity at 25° C.)

| Salt | % RH |
|---|---|
| Cesium fluoride | 3.39 ± 0.94 |
| Lithium bromide | 6.37 ± 0.52 |
| Zinc bromide | 7.75 ± 0.39 |
| Potassium hydroxide | 8.23 ± 0.72 |
| Sodium hydroxide | 8.24 ± 2.1 |
| Lithium chloride | 11.30 ± 0.27 |
| Zinc chloride* | 15.60 ± 0.94* |
| Calcium bromide | 16.50 ± 0.20 |
| Lithium iodide | 17.56 ± 0.13 |
| Potassium acetate | 22.51 ± 0.32 |
| Potassium fluoride | 30.85 ± 1.3 |
| Magnesium chloride | 32.78 ± 0.16 |
| Sodium iodide | 38.17 ± 0.50 |
| Magnesium nitrate | 52.89 ± 0.22 |
| Sodium bromide | 57.57 ± 0.40 |
| Sodium chloride | 75.29 ± 0.12 |

*measured at 31 ± 4° C.

### Preparatory Example P1

### Ni²⁺/dimethylglyoxime/Al₂O₃ Microbeads

Alumina microbeads (20.12 g) were added to a nickel acetate solution (40.04 g) in a glass jar. The jar was capped and the contents were mixed on a jar roller for 12 minutes at room temperature. The mixture was then vacuum filtered through a #5 Whatman filter paper in a 125 mm Buchner funnel. The microbeads on the filter paper were washed twice with 100 mL of deionized water and then dried in a glass Petri dish in an oven at 110° C. for 15 minutes. The dried microbeads were added directly to a basic dimethylglyoxime solution prepared by mixing 0.12 g dimethylglyoxime, 11.55 g aqueous KOH, and 28.42 g of deionized water. The microbeads rapidly changed to a pink color. The mixture was stirred by hand for 2 minutes, then washed and decanted three times with 70 mL deionized water. The mixture was then vacuum filtered through a #5 Whatman filter paper in a 125 mm Buchner funnel The microbeads on the filter were washed twice with approximately 100 mL of deionized water. Any nickel dimethylglyoxime formed as a film on the wash water surface was skimmed off. The pH of the last wash in the funnel was 8.5. The bright pink, uniformly colored microbeads were transferred to a glass Petri dish and dried for 90 minutes in an oven at 110° C. in air. The dried Ni²⁺/dimethylglyoxime/Al₂O₃ microbeads were green-yellow in color.

### Preparatory Example P2

### Ni²⁺/dimethylglyoxime/SiO₂ Microbeads

Silica microbeads (3.57 g) were added to a nickel acetate solution (11.08 g) in a flask. The mixture was swirled for 12 minutes, and then filtered through a #5 Whatman filter paper in a Buchner funnel The microbeads on the filter paper were washed with deionized water and collected in a vial. A basic dimethylglyoxime solution (17.6 g) was prepared by mixing 0.11 g dimethylglyoxime, 10.37 g of aqueous KOH, and 25.56 g of deionized water, and added to the vial of microbeads. The microbeads rapidly changed to a pink color with a pink supernatant. The mixture was washed and decanted with deionized water several times, and then vacuum filtered through a #5 Whatman filter paper. The microbeads on the filter were washed twice with deionized water. Any nickel dimethylglyoxime formed as a film on the wash water surface was skimmed off. The microbeads were then transferred to a glass Petri dish and dried in an oven at 110° C. for 1-2 hours in air. The dried Ni²⁺/dimethylglyoxime/SiO₂ microbeads were green-yellow in color.

### Preparatory Example P3

### Ni²⁺/dimethylglyoxime/polymeric Resin Beads

Polymeric beads (0.10 g) were immersed for 15 minutes in a nickel acetate solution (3.25 g) in a 10 mL glass vial. The beads were then washed with deionized water and decanted at least 3 times until the supernatant was colorless, and decanted. A basic dimethylglyoxime solution (4.93 g) was prepared by mixing 0.12 g of dimethylglyoxime, 11.54 g of 1M aqueous solution of potassium hydroxide, and 28.34 g of deionized water, and added to the vial of beads. After mixing for 60 seconds, the beads were washed with deionized water and decanted at least 3 times until the supernatant was colorless. The wet, dark pink beads were transferred to a glass Petri dish, and dried in an oven at 110° C. in air for 66 hours. The dried Ni²⁺/dimethylglyoxime/polymeric resin beads were dark green in color.

### Examples 1-5

### Salt/Ni²⁺/dimethylglyoxime/Al₂O₃ Microbead Mixtures

The following salts were each ground in a ceramic mortar and pestle by hand for several minutes to produce micron sized particles of each salt: NaCl, Mg(NO₃)₂, MgCl₂, LiCl, and LiBr. Indicator compositions were prepared with 0.5 g of each salt and 0.5 g of Ni²⁺/dimethylglyoxime/Al₂O₃ microbeads from Preparatory Example P1 as shown in Table 2. That is, the indicator composition included 50 weight percent salt and 50 weight percent Ni²⁺/dimethylglyoxime/Al₂O₃ microbeads. Each composition was mixed for several minutes in a vortex mixer (Maxi Mix II Vortex Mixer, Model M37615, Barnstead/Thermolyne; Dubuque, Iowa).

The critical relative humidity values of the salts shown in Table 2 were obtained from literature reference 2 above (Greenspan et al.).

TABLE 2

| | | Critical relative | | |
|---|---|---|---|---|
| | | humidity | Salt | Ni²⁺/dimethylglyoxime/Al₂O₃ |
| Ex | Salt | at 25° C. (%) | (wt %) | microbeads (wt %) |
| 1 | NaCl | 75.29 ± 0.12 | 50 | 50 |
| 2 | Mg(NO₃)₂ | 52.89 ± 0.22 | 50 | 50 |
| 3 | MgCl2 | 32.78 ± 0.16 | 50 | 50 |
| 4 | LiCl | 11.30 ± 0.27 | 50 | 50 |
| 5 | LiBr | 6.37 ± 0.52 | 50 | 50 |

### Comparative Example 1 and Examples 6-10

### Indicator Tapes

Indicator tapes in Comparative Example 1 and Examples 5-10 were prepared as described above using the indicator compositions from Example P1 and Examples 1-5, respectively. The tapes were exposed to step changes from 0%-80% in 10% increments of relative humidity in the test chamber described in the Test Methods described above. The tape was exposed for a sufficient time to reach the equilibrium relative humidity for each humidity level in the test chamber and until no further change in the color occurred. The relative humidity was then increased to the next level of humidity. A plot of the percent reflection intensity versus wavelength was measured during each change in % RH and the data was correlated to the RGB color from the spectra, as shown in Table 3. The relative humidity at which a significant change in color occurred can be correlated to the critical relative humidity. The indicator compositions comprising hygroscopic salts (i.e. modified moisture-indicating compositions) showed significant color change at lower humidity levels than the indicator composition without a hygroscopic salt (i.e. a moisture-indicating composition).

TABLE 3

| | | Color at varying relative humidity levels | | | | | | | | |
|---|---|---|---|---|---|---|---|---|---|---|
| Ex | Salt | 0% | 10% | 20% | 30% | 40% | 50% | 60% | 70% | 80% |
| CE1 | None | Green- | Green- | Green- | Green- | Yellow | Orange | Orange- | Pink | Pink |
| | | Yellow | Yellow | Yellow | Yellow | | | Pink | | |
| 6 | NaCl | Green- | Green- | Green- | Green- | Orange | Orange- | Pink | Pink | Pink |
| | | Yellow | Yellow | Yellow | Yellow | | Pink | | | |
| 7 | Mg(NO₃)₂ | Green- | Green- | Green- | Green- | Orange- | Pink | Pink | Pink | Pink |
| | | Yellow | Yellow | Yellow | Yellow | Pink | | | | |
| 8 | MgCl₂ | Green- | Green- | Green- | Orange- | Pink | Pink | Pink | Pink | Pink |
| | | Yellow | Yellow | Yellow | Pink | | | | | |
| 9 | LiCl | Green- | Green- | Pink | Pink | Pink | Pink | Pink | Pink | Pink |
| | | Yellow | Yellow | | | | | | | |
| 10 | LiBr | Green- | Orange- | Pink | Pink | Pink | Pink | Pink | Pink | Pink |
| | | Yellow | Pink | | | | | | | |

### Comparative Example 2 and Examples 11-13

### LiCl/Ni²⁺/dimethylglyoxime/Al₂O₃ Microbead Mixtures & Tapes

Indicator compositions were prepared as described in Examples 1-5 except with 25%, 50%, and 75 wt % lithium chloride for Examples 11-13, respectively. Correspondingly, these examples contained 75%, 50%, and 25 wt % Ni²⁺/dimethylglyoxime/Al₂O₃ microbeads. Indicator tapes were prepared with the indicator compositions of P1 (Comparative Example 2). Refection spectra were measured and correlated to the RGB color from the spectra, as shown in Table 4. The results indicate that increasing the amount of lithium chloride shifted the humidity at which a significant color change occurred to a lower level.

TABLE 4

| | LiCl | Color at varying relative humidity levels | | | | | | | | |
|---|---|---|---|---|---|---|---|---|---|---|
| Ex | (wt %) | 0% | 10% | 20% | 30% | 40% | 50% | 60% | 70% | 80% |
| CE2 | 0% | Green- | Green- | Green- | Green- | Yellow | Orange | Orange- | Pink | Pink |
| | | Yellow | Yellow | Yellow | Yellow | | | Pink | | |
| 11 | 25% | Green- | Green- | Orange- | Pink | Pink | Pink | Pink | Pink | Pink |
| | | Yellow | Yellow | Pink | | | | | | |
| 12 | 50% | Green- | Green- | Pink | Pink | Pink | Pink | Pink | Pink | Pink |
| | | Yellow | Yellow | | | | | | | |
| 13 | 75% | Green- | Pink | Pink | Pink | Pink | Pink | Pink | Pink | Pink |
| | | Yellow | | | | | | | | |

### Comparative Example 3 and Examples 14-15

### LiBr/Ni²⁺/dimethylglyoxime/Al₂O₃ Microbead Mixtures & Tapes

Indicator compositions were prepared as described in Examples 1-5 except with 50% and 75 wt % lithium bromide and correspondingly, 50% and 25 wt % Ni²⁺/dimethylglyoxime/Al₂O₃ microbeads. Tapes were prepared from each composition (Examples 14-15) or P1 (Comparative Example 3). Refection spectra were measured for the tapes and correlated to the RGB color from the spectra, as shown in Table 5. Results in Table 5 show that increasing the amount of lithium bromide caused the color change to occur at lower relative humidity levels.

TABLE 5

| | LiBr | Color at varying relative humidity levels | | | | | | | | |
|---|---|---|---|---|---|---|---|---|---|---|
| Ex | (wt %) | 0% | 3.5% | 5% | 7.5% | 10% | 20% | 30% | 40% | 50% |
| CE3 | 0 | Green- | Green- | Green- | Green- | Green- | Green- | Green- | Yellow | Orange |
| | | Yellow | Yellow | Yellow | Yellow | Yellow | Yellow | Yellow | | |
| 14 | 50 | Green- | Green- | Green- | Orange- | Pink | Pink | Pink | Pink | Pink |
| | | Yellow | Yellow | Yellow | Pink | | | | | |
| 15 | 75 | Green- | Green- | Orange- | Pink | Pink | Pink | Pink | Pink | Pink |
| | | Yellow | Yellow | Pink | | | | | | |

### Example 16

### Moisture Indicator Card

Individual indicator tapes, I-IV, were prepared with the indicator compositions shown in Table 6.

TABLE 6

| | | | Wt Ratio of Salt to | |
|---|---|---|---|---|
| | | | Ni²⁺/dimethylglyoxime/ | RH |
| Tape | Salt | Example | Al₂O₃ microbeads | Indicator Range |
| I | LiBr | 15 | 75:25 | 5% |
| II | LiCl | 13 | 75:25 | 10% |
| III | MgCl₂ | 3 | 50:50 | 40% |
| IV | None | P1 | 0:100 | 60% |

All four indicator tapes were suspended adjacent to each other in the test chamber so that they were tested simultaneously. The indicator tapes were placed in order of the indicator tapes as they might appear on an indicator card with the indicator tape sides against the top glass plate and the paper sides of each indicator tape facing the bottom of the test chamber.

A digital image of the indicator tapes was taken with a camera (Canon PowerShot SD960 IS, in the macro-mode) after 30 minutes in dry air (0% RH). The indicator tapes were then held at increasing relative humidity levels in 10% increments until no color change was observed in all of the tapes for 30 minutes. A digital image was taken of the indicator tapes before increasing to the next humidity level. Times of exposure ranged from 30 minutes to 2 hours. A composite image was prepared by merging all of the digital images into a single image having the changes in Color shown in Table 7 for each Tape I, II, III, and IV and the relative humidity levels shown.

TABLE 7

| | Color at varying relative humidity levels | | | | | | | | | | | |
|---|---|---|---|---|---|---|---|---|---|---|---|---|
| Tape | 0% | 3.5% | 5% | 7.5% | 10% | 15% | 20% | 30% | 40% | 50% | 60% | 70% |
| I | Green- | Green- | Orange- | Pink | Pink | Pink | Pink | Pink | Pink | Pink | Pink | Pink |
| | Yellow | Yellow | Pink | | | | | | | | | |
| II | Green- | Green- | Green- | Green- | Orange- | Pink | Pink | Pink | Pink | Pink | Pink | Pink |
| | Yellow | Yellow | Yellow | Yellow | Pink | | | | | | | |
| III | Green- | Green- | Green- | Green- | Green- | Green- | Green- | Orange- | Pink | Pink | Pink | Pink |
| | Yellow | Yellow | Yellow | Yellow | Yellow | Yellow | Yellow | Pink | | | | |
| IV | Green- | Green- | Green- | Green- | Green- | Green- | Green- | Green- | Yellow | Orange | Orange- | Pink |
| | Yellow | Yellow | Yellow | Yellow | Yellow | Yellow | Yellow | Yellow | | | Pink | |

### Comparative Example 4 and Examples 17-18

### Ni²⁺/dimethylglyoxime/SiO₂ Microbeads

Indicator compositions were prepared as described in Examples 1-5 except as follows. Preparatory Example P2 was used instead of P1. Comparative Example 4 was prepared with only P2. The composition of Example 17 was 50:50 MgCl₂:P2(MgCl₂/Ni²⁺/dimethylglyoxime/SiO₂microbeads). The composition of Example 18 was 75:25 LiCl:P2(LiCl/Ni²⁺/dimethylglyoxime/SiO₂microbeads). Indicator tapes were prepared with the compositions. The RGB color from the reflection spectra is shown in Table 8. Sharp, distinct changes in color were observed at 10% RH, 40% RH, and 60% RH.

TABLE 8

| | Color at varying relative humidity levels | | | | | | | | | | |
|---|---|---|---|---|---|---|---|---|---|---|---|
| Ex | 0% | 5% | 7.5% | 10% | 20% | 30% | 40% | 50% | 60% | 70% | 80% |
| CE4 | Green- | Green- | Green- | Green- | Green- | Green- | Green- | Yellow | Orange- | Pink | Pink |
| | Yellow | Yellow | Yellow | Yellow | Yellow | Yellow | Yellow | | Pink | | |
| 17 | Green- | Green- | Green- | Green- | Green- | Green- | Pink | Pink | Pink | Pink | Pink |
| | Yellow | Yellow | Yellow | Yellow | Yellow | Yellow | | | | | |
| 18 | Green- | Green- | Green- | Pink | Pink | Pink | Pink | Pink | Pink | Pink | Pink |
| | Yellow | Yellow | Yellow | | | | | | | | |

### Example 19

### MgCl₂/Ni²⁺/dimethylglyoxime/SiO₂ Microbeads Indicator Tape

An indicator tape was prepared from the indicator composition having 50 wt % MgCl₂ and 50 wt % Ni²⁺/dimethylglyoxime/SiO₂microbeads, and exposed to humidities in the range of 30% to 40% RH in 1% or 2% increments. The ambient temperature in the test chamber was 22.3° C. The RGB color from the reflection spectra is shown in Table 9. A sharp color change occurred at about 34% RH, which corresponds to the critical relative humidity of MgCl₂ reported by Trofimenkoff et al. as 33.2, at 21.7° C. (reference 1 above).

TABLE 9

| | Color at varying relative humidity levels | | | | | | | | |
|---|---|---|---|---|---|---|---|---|---|
| Ex | 0.0% | 30.0% | 32.1% | 33.0% | 34.0% | 35.0% | 36.0% | 37.9% | 40.2% |
| 19 | Green- | Green- | Green- | Green- | Pink | Pink | Pink | Pink | Pink |
| | Yellow | Yellow | Yellow | Yellow | | | | | |

### Comparative Example 5 and Example 20

### (Ni²⁺/dimethylglyoxime/polymeric Beads)

Indicator compositions were prepared as described in Examples 1-5 except as follows. Preparatory Example P3 was used instead of P1. Comparative Example 5 was prepared with only P3 (Ni²⁺/dimethylglyoxime/polymeric resin beads). Example 20 was prepared with a mixture of 75 wt % MgCl₂ and 25 wt % Ni²⁺/dimethylglyoxime/polymeric resin beads of Example P3. Indicator tapes were prepared, tested, and imaged as described in Example 16 except as specified below. The indicator tape for Comparative Example 5 contained only the indicator composition from Example P3, and the indicator tape for Example 20 contained 75 wt % MgCl₂ and 25 wt % Ni²⁺/dimethylglyoxime/polymeric resin beads of Example P3 (Example 20 was therefore MgCl₂/Ni²⁺/dimethylglyoxime/polymeric resin beads). The indicator tapes were simultaneously exposed to increasing humidity levels and held at each humidity level until the color change had stabilized and no color change was observed for at least 20 minutes in either tape. The indicator tapes were exposed between 20 to 90 minutes for a given humidity level. The temperature in the test chamber was 22.9±0.2° C.

The indicator tape with only P3 changed color at 60˜70% RH while the tape with the MgCl₂/Ni²⁺/dimethylglyoxime/polymeric resin beads indicator composition showed a very sharp color change at 30˜40% RH as shown in Table 10. The relative humidity at which significant change occurred can be correlated to the critical relative humidity of MgCl₂ reported by Trofimenkoff et al. as was 33.2, at 21.7° C. (reference 1 above).

TABLE 10

| | Color at varying relative humidity levels | | | | | | | | |
|---|---|---|---|---|---|---|---|---|---|
| Ex | 0% | 10% | 20% | 30% | 40% | 50% | 60% | 70% | 80% |
| CE5 | Dark | Dark | Dark | Dark | Dark | Dark | Dark | Dark red | Dark red |
| | green | green | green | green | green | green | green-red | | |
| 20 | Dark | Dark | Dark | Dark | Dark red | Dark red | Dark red | Dark red | Dark red |
| | green | green | green | green | | | | | |

### Comparative Example 6 and Example 21

### KOAc/Ni²⁺/dimethylglyoxime/Al₂O₃ Microbeads

Indicator compositions were prepared as described in Examples 1-5 and P1 except as follows. The Comparative Example 6 indicator composition was prepared with P1 only (Ni²⁺/dimethylglyoxime/Al₂O₃ microbeads). The Example 21 indicator composition was prepared with 50 wt % KOAc and 50 wt % Ni²⁺/dimethylglyoxime/Al₂O₃ microbeads. Approximately 0.1 gram of the indicator compositions for Comparative Example 6 and Example 21 were each placed in vials. Approximately 5 mL of a saturated MgCl₂ solution was placed in each of two 4-ounce glass jars. One vial was placed in each jar, and the jars were capped. The jars were kept overnight at room temperature during which the atmosphere in the closed jars reached an equilibrium relative humidity of 33%. Vials were also prepared and kept overnight at 0% RH. The color was visually observed the next day for each composition and summarized in Table 11. The critical relative humidity of KOAc reported in the literature is 22.51% at 25° C.

TABLE 11

| | KOAc:Ni²⁺/dimethylglyoxime/ | | |
|---|---|---|---|
| Ex | Al₂O₃ microbead Wt Ratio | Color RH 0% | Color RH 33% |
| CE6 | 0:100 | Green-Yellow | Green-Yellow |
| 21 | 50:50 | Green-Yellow | Pink |

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A colorimetric moisture-indicating composition comprising:
a modified moisture-indicating composition comprising
a moisture-indicating composition comprising
a solid support; and
a bis(glyoxime)-transition metal complex bound to the solid support; and
a modifier comprising at least one hygroscopic salt,
wherein the at least one hygroscopic salt comprises an anion selected from the group comprising halide, nitrate, acetate, carbonate, and hydroxide; and
wherein the at least one hygroscopic salt comprises a cation selected from the group comprising ammonium, an alkali metal, an alkaline earth metal, and a transition metal; and
wherein the modifier is in physical contact with or in fluid communication with the moisture-indicating composition.

2. The colorimetric moisture-indicating composition of claim 1, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

3. The colorimetric moisture-indicating composition of claim 1, wherein the at least one hygroscopic salt has a critical relative humidity ranging from about 3% to about 80% relative humidity at 25° C.

4. The colorimetric moisture-indicating composition of claim 3, wherein the at least one hygroscopic salt has a critical relative humidity of from about 3% to about 40% relative humidity at 25° C.

5. The colorimetric moisture-indicating composition of claim 1, wherein the solid support comprises an inorganic support.

6. The colorimetric moisture-indicating composition of claim 1, wherein the inorganic support comprises a metal oxide.

7. The colorimetric moisture-indicating composition of claim 6, wherein the metal oxide comprises an oxide of aluminum, silicon, or a combination thereof.

8. The colorimetric moisture-indicating composition of claim 6, wherein the metal oxide comprises an oxide of zirconium, titanium, or a combination thereof.

9. The colorimetric moisture-indicating composition of claim 5, wherein the inorganic support comprises at least one of a sulfate, a carbonate, and a phosphate.

10. The colorimetric moisture-indicating composition of claim 1, wherein the solid support comprises an organic polymeric support.

11. The colorimetric moisture-indicating composition of claim 10, wherein the organic polymeric support is an ion exchange polymer.

12. The colorimetric moisture-indicating composition of claim 1, any of the wherein the transition metal in the bis(glyoxime)-transition metal complex comprises rhodium, iridium, platinum, palladium, gold, nickel, copper, or a combination thereof.

13. The colorimetric moisture-indicating composition of claim 12, wherein the bis(glyoxime)-transition metal complex comprises bis(dimethylglyoximato)-nickel (II).

14. A colorimetric relative humidity-indicating sensor comprising:
a colorimetric moisture-indicating composition according to claim 1,
wherein an optical spectrum of the sensor changes quantitatively according to a relative humidity of an environment within which the sensor is placed.

15. The sensor of claim 14, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

16. The sensor of claim 14, wherein the sensor quantitatively changes reflection spectrum at relative humidities ranging from about 3% to about 80% relative humidity at 25° C.

17. The sensor of claim 14, wherein the sensor quantitatively changes reflection spectrum at relative humidities ranging from about 3% to about 40% relative humidity at 25° C.

18. The sensor of claim 14, wherein the bis(glyoxime)-transition metal complex comprises bis(dimethylglyoximato)-nickel (II).

19. A method of adjusting the colorimetric response of a moisture-indicating composition comprising:
combining a moisture-indicating composition having a first critical relative humidity with at least one hygroscopic salt having a second critical relative humidity that differs from the first critical relative humidity to make a modified moisture-indicating composition; and wherein the at least one hygroscopic salt is in physical contact with or in fluid communication with the moisture-indicating composition,
wherein the moisture-indicating composition comprises
a solid support; and
a bis(glyoxime)-transition metal complex bound to the solid support; and
wherein the at least one hygroscopic salt comprises an anion selected from the group comprising halide, nitrate, acetate, carbonate, and hydroxide;
wherein the at least one hygroscopic salt comprises a cation selected from the group comprising ammonium, an alkali metal, an alkaline earth metal, and a transition metal; and
wherein the critical relative humidity of the modified moisture-indicating composition differs from the critical relative humidity of the moisture-indicating composition.

20. The method of claim 19, wherein the at least one hygroscopic salt comprises at least one of lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

21. The method of claim 19, wherein the bis(glyoxime)-transition metal complex comprises bis(dimethylglyoximato)-nickel (II).

22. A colorimetric moisture-indicating card comprising a colorimetric moisture-indicating composition of claim 1.

23. A colorimetric moisture-indicating card comprising a modified moisture-indicating composition comprising
a moisture-indicating composition of claim 1,
wherein the modifier is in physical contact with or in fluid communication with the moisture-indicating composition.
